(19) United States
(12) Patent Application Publication
(10) Pub. No.: US 2024/0287344 A1
(43) Pub. Date: Aug. 29, 2024

(54) Ink Jet Printing Penetrant And Ink Jet Recording Method

(71) Applicant: SEIKO EPSON CORPORATION, Tokyo (JP)

(72) Inventors: Yasuhiro OKI, Matsumoto (JP); Hidehiko KOMATSU, Chino (JP)

(21) Appl. No.: 18/588,487

(22) Filed: Feb. 27, 2024

(30) Foreign Application Priority Data
Feb. 28, 2023 (JP) 2023-029095

(51) Int. Cl. C09D 11/54; C09D 11/328; C09D 11/38; D06P 1/16; D06P 1/38; D06P 1/642; D06P 1/92; D06P 5/00; D06P 5/30

(52) U.S. Cl. CPC C09D 11/54; C09D 11/328; C09D 11/38; D06P 1/16; D06P 1/38; D06P 1/6426; D06P 1/928; D06P 5/002; D06P 5/30

(57) ABSTRACT

An ink jet printing penetrant includes a lactam compound having a hydroxy group and a glycol having a vapor pressure of 1.0 to 20.0 Pa at 20° C., a content of the lactam compound with respect to a total mass of the ink jet printing penetrant is 15 to 25 percent by mass, and a content of the glycol with respect to a total mass of the lactam compound is 0.8 to 3.0 on a mass ratio basis.

The present application is based on, and claims priority from JP Application Serial Number 2023-029095, filed Feb. 28, 2023, the disclosure of which is hereby incorporated by reference herein in its entirety.

### BACKGROUND

### 1. Technical Field

The present disclosure relates to an ink jet printing penetrant and an ink jet recording method.

### 2. Related Art

Since being able to record a highly fine image using a relatively simple apparatus, an ink jet recording method has been rapidly developed in various fields. Among the developments, various types of studies on printing methods using an ink jet method have been carried out.

For example, JP-A-2016-141802 has disclosed an ink jet printing penetrant containing water and a lactam compound, the content of which is 20 percent by mass or more.

In recent years, in ink jet printing, in order to obtain an image having a preferable color development property not only on a front surface of a cloth but also on a rear surface thereof, an ink has been required to permeate through to the rear surface described above.

In view of the point described above, the penetrant disclosed in JP-A-2016-141802 still has some room for improvement.

### SUMMARY

Through intensive research carried out by the present inventors to solve the problem described above, it was finally found that the above problem can be solved by using a penetrant having a predetermined composition, and as a result, the present disclosure was completed.

According to an aspect of the present disclosure, there is provided an ink jet printing penetrant comprising: a lactam compound having a hydroxy group; and a glycol having a vapor pressure of 1.0 to 20.0 Pa at 20° C. In the ink jet printing penetrant described above, a content of the lactam compound with respect to a total mass of the ink jet printing penetrant is 15 to 25 percent by mass, and a content of the glycol with respect to a total mass of the lactam compound is 0.8 to 3.0 on a mass ratio basis.

According to another aspect of the present disclosure, there is provided an ink jet recording method comprising: an ink adhesion step of adhering an aqueous dye ink containing a reactive dye, an acidic dye, or a disperse dye to a cloth by an ink jet method; and a penetrant adhesion step of adhering the ink jet printing penetrant of the present disclosure to the cloth by an ink jet method.

### BRIEF DESCRIPTION OF THE DRAWINGS

FIG. 1 is a table showing results of Examples.

FIG. 2 is a table showing results of Examples.

FIG. 3 is a table showing results of Examples.

FIG. 4 is a table showing results of Examples.

### DESCRIPTION OF EMBODIMENTS

Hereinafter, although embodiments (hereinafter, each referred to as “this embodiment”) of the present disclosure will be described in detail, the present disclosure is not limited thereto and may be variously changed and/or modified without departing from the scope of the present disclosure.

### 1. Ink Jet Printing Penetrant

An ink jet printing penetrant of this embodiment contains a lactam compound having a hydroxy group and a glycol having a vapor pressure of 1.0 to 20.0 Pa at 20° C., a content of the lactam compound with respect to a total mass of the ink jet printing penetrant is 15 to 25 percent by mass, and a content of the glycol with respect to a total mass of the lactam compound is 0.8 to 3.0 on a mass ratio basis.

Since containing the lactam compound having a hydroxy group excellent in water solubility at the content described above and the glycol having a predetermined vapor pressure on the mass ratio basis described above, the ink jet printing penetrant of this embodiment is excellent in permeability of an acidic dye, a reactive dye, and a disperse dye. As a result, even when any one of an acidic dye, a reactive dye, and a disperse dye is used, the difference in dyeing concentration between a front surface and a rear surface of a cloth or the like can be reduced, and a recorded matter excellent in color development property can be obtained. In other words, it can be said that the ink jet printing penetrant of this embodiment is used for both printing of cotton with an acidic dye or a reactive dye and printing of polyester fibers with a disperse dye.

In addition, although a penetrant containing a lactam compound, such as 2-pyrrolidone, used in the past has a predetermined effect to improve the permeability of an acidic dye or a reactive dye, as for a disperse dye, 2-pyrrolidone is likely to dissolve a disperse dye, and hence dyeing failure is disadvantageously liable to occur. Accordingly, although 1,3-propylene glycol, 1,4-butanedol, or the like is used as a penetrant for a disperse dye, the permeability is inferior, and as a result, the permeability of an acidic dye or a reactive dye is not likely to be improved thereby.

Hence, in the past, penetrants for an acidic dye, a reactive dye, and a disperse dye were required to be used separately from each other. However, since a cotton/polyester blend used as a functional cloth has been recently increased in volume, a reactive dye and a disperse dye are required to be simultaneously printed, and as a result, a penetrant usable for an acidic dye, a reactive dye, and a disperse dye has been required.

On the other hand, since the ink jet printing penetrant of this embodiment contains the lactam compound having a hydroxy group excellent in water solubility at the content described above and the glycol having a predetermined vapor pressure on the mass ratio basis described above, while the permeability of each dye is improved, the ink jet printing penetrant described above suppresses dyeing inhibition, dissolution of a disperse dye, and/or the like. Hence, the ink jet printing penetrant of this embodiment can be applied not only to printing using an acidic dye or a reactive dye but also to printing using a disperse dye.

### 1.1. Lactam Compound Having Hydroxy Group

The ink jet printing penetrant of this embodiment contains a lactam compound having a hydroxy group.

Although the lactam compound having a hydroxy group is not particularly limited, for example, at least one selected from the group consisting of 1-(2-hydroxyethyl)-2-pyrrolidone, 1-(2-hydroxyethyl)-3-methyl-2-pyrrolidone, 4-hydroxy-2-pyrrolidone, and 6-hydroxymethyl-2-piperidone is preferable, and 1-(2-hydroxyethyl)-2-pyrrolidone is more preferable.

Since the lactam compound as described above is used, even when any one of an acidic dye, a reactive dye, and a disperse dye is used, the permeability thereof can be improved while a dyeing property is maintained, and hence, a printed matter having a small difference in dyeing concentration between front and rear surfaces can be obtained with a preferable color development property.

A content of the lactam compound having a hydroxy group with respect to the total mass of the ink jet printing penetrant is 15 to 25 percent by mass and preferably 18 to 23 percent by mass.

Since the content of the lactam compound having a hydroxy group is 15 percent by mass or more, the permeability is excellent, and hence, a printed matter having a small difference in dyeing concentration between front and rear surfaces can be obtained with a preferable color development property. In addition, since the content of the lactam compound having a hydroxy group is 25 percent by mass or less, the dyeing inhibition caused by a reaction between the lactam compound having a hydroxy group and a reactive dye can be suppressed, and hence, a printed matter having a small difference in dyeing concentration between front and rear surfaces can be obtained with a preferable color development property.

### 1.2. Glycol

The ink jet printing penetrant of this embodiment contains a glycol having a vapor pressure of 1.0 to 20.0 Pa at 20° C. The glycol described above may be contained as an organic solvent. The glycol described above may be used alone, or at least two types thereof may be used in combination.

Since having a vapor pressure of 1.0 Pa or more at 20° C., the glycol described above is relatively easily evaporated, and the dyeing inhibition of an acidic dye or a reactive dye is suppressed. In addition, the lactam compound described above can be prevented from remaining at a front surface side due to excessive permeation of the glycol.

Since the vapor pressure of the glycol at 20° C. is 20.0 Pa or less, the permeability of the glycol is excellent.

The vapor pressure of the glycol at 20° C. is preferably 3.0 to 18.0 Pa, more preferably 5.0 to 16.5 Pa, even more preferably 6.5 to 15.0 Pa, and further preferably 8.0 to 13.5 Pa.

As the glycol described above, for example, there may be mentioned ethylene glycol (vp.: 7.0 Pa), propylene glycol (vp.: 10.6 Pa), 1,3-butanediol (vp.: 8.0 Pa), 2,3-butanediol (vp.: 12.0 Pa), 2-methyl-2,4-pentanediol (vp.: 6.7 Pa), or methanediol (vp.: 16.1 Pa). In addition, vp. is the abbreviation of a vapor pressure at 20° C.

The glycol preferably includes propylene glycol. Since the glycol as described above is used, even when any one of an acidic dye, a reactive dye, and a disperse dye is used, the permeability thereof can be improved while the dyeing property is maintained, and hence, a printed matter having a small difference in dyeing concentration between front and rear surfaces can be obtained with a preferable color development property.

A content of the glycol with respect to the total mass of the lactam compound on a mass ratio basis is preferably 0.8 to 3.0, more preferably 0.9 to 2.5, even more preferably 0.9 to 2.0, and further preferably 0.9 to 1.5.

Since the content of the glycol with respect to the total mass of the lactam compound on a mass ratio basis is 0.8 or more, the permeability through to the rear surface of a cloth or the like is excellent. In addition, when the ink jet printing penetrant of this embodiment is used together with a reactive dye, the dyeing inhibition can be suppressed.

Since the content of the glycol with respect to the total mass of the lactam compound on a mass ratio basis is 3.0 or less, the permeability of the lactam compound having a hydroxy group can be suppressed from being excessively increased. As a result, a disperse dye can be prevented from remaining in a large amount at a front surface side since the dye is not allowed to permeate.

The content of the glycol with respect to the total mass of the ink jet printing penetrant is preferably 15 to 60 percent by mass, more preferably 20 to 50 percent by mass, even more preferably 20 to 40 percent by mass, and further preferably 20 to 30 percent by mass. Since the content of the glycol is in the range described above, even when any one of an acidic dye, a reactive dye, and a disperse dye is used, the permeability thereof can be improved while the dyeing property is maintained, and hence, a printed matter having a small difference in dyeing concentration between front and rear surfaces can be obtained with a preferable color development property.

### 1.3. Water

As the water, for example, pure water, such as ion exchange water, ultrafiltration water, reverse osmosis water, or distilled water may be mentioned, and water, such as ultrapure water, in which ionic impurities are removed as much as possible may also be mentioned. In addition, in the case in which water sterilized by UV radiation or addition of hydrogen peroxide is used, generation of fungi and/or bacteria can be prevented when the ink jet printing penetrant is stored for a long time.

A content of the water with respect to 100 percent by mass of the ink jet printing penetrant is preferably 30 to 80 percent by mass, more preferably 35 to 75 percent by mass, and further preferably 40 to 70 percent by mass.

### 1.4. Surfactant

The ink jet printing penetrant may further contain a surfactant. The surfactant is not particularly limited, and for example, a nonionic surfactant, a cationic surfactant, or an anionic surfactant may be mentioned. Among those mentioned above, a nonionic surfactant is preferable. Since the nonionic surfactant is used, an ejection stability tends to be further improved.

The nonionic surfactant is not particularly limited, and for example, a silicone-based surfactant, an acetylene glycol-based surfactant, a polyoxyethylene alkyl ether-based surfactant, a polyoxypropylene alkyl ether-based surfactant, a polycyclic phenyl ether-based surfactant, a sorbitan derivative-based surfactant, or a fluorine-based surfactant may be mentioned. Among those mentioned above, an acetylene glycol-based surfactant is preferable. Since the acetylene glycol-based surfactant is used, the permeability tends to be further improved.

The acetylene glycol-based surfactant is not particularly limited, and for example, at least one selected from the group consisting of 2,4,7,9-tetramethyl-5-decyne-4,7-diol, an alkylene oxide adduct thereof, 2,4-dimethyl-5-decyne-4-ol, and an alkylene oxide adduct thereof is preferable. A commercial product of the acetylene glycol-based surfactant is not particularly limited, and for example, there may be mentioned Olfine PD002W, Olfine 104 Series, or E Series such as Olfine E1010 (trade name, manufactured by Nissin Chemical Industry Co., Ltd.), or Surfynol 465 or Surfynol 61 (trade name, manufactured by Air Products Japan, Inc.). The surfactant may be used alone, or at least two types thereof may be used in combination.

A content of the surfactant with respect to 100 percent by mass of the ink jet printing penetrant is preferably 0.10 to 1.0 percent by mass, more preferably 0.20 to 0.75 percent by mass, and further preferably 0.30 to 0.60 percent by mass. Since the content of the surfactant is 0.10 percent by mass or more, the permeability tends to be further improved. In addition, since the content of the surfactant is 1.0 percent by mass or less, the ejection stability tends to be suppressed from being degraded.

### 1.5. Other Components

The ink jet printing penetrant may further contain an urea, a saccharide, a pH adjuster, a chelating agent, a fungicide, an antirust agent, and/or other components.

The ink jet printing penetrant is not an ink composition and preferably contains no colorant. In particular, in order to clearly discriminate between the ink jet printing penetrant and the ink composition, a content of the colorant with respect to the total mass of the ink jet printing penetrant is preferably 0.1 percent by mass or less, more preferably 0.01 percent by mass or less, and particularly preferably 0 percent by mass. Since the content of the colorant is controlled as described above, a portion to which the penetrant is adhered can be prevented from being unintentionally colored.

The ink jet printing penetrant is not an ink composition and preferably contains no solid component such as resin particles. In particular, in order to clearly discriminate between the ink jet printing penetrant and the ink composition, a content of the solid component with respect to the total mass of the ink jet printing penetrant is preferably 1.0 percent by mass or less, more preferably 0.1 percent by mass or less, further preferably 0.01 percent by mass, and particularly preferably 0 percent by mass. In addition, in this specification, a component (such as DMI (1,3-dimethyl-2-imidazolidinone) which is a solid at ordinary temperature but is dissolved in water is not included in the solid component.

### 2. Ink Jet Recording Method

Next, an ink jet recording method using the ink jet printing penetrant of this embodiment will be described.

The ink jet recording method includes an ink adhesion step of adhering an aqueous dye ink containing a reactive dye, an acidic dye, or a disperse dye to a cloth by an ink jet method; and a penetrant adhesion step of adhering the ink jet printing penetrant of this embodiment to the cloth by an ink jet method.

As a recorded matter (may also be a printed matter), a cloth having similar patterns recorded on a front surface and a rear surface may be required in some cases. As a method to form the recorded matter as described above, a method may be mentioned in which before and after an ink composition is adhered to a cloth, a penetrant to induce permeation of the ink composition is adhered to the cloth. However, depending on the composition of the penetrant, the dyeing inhibition (dye being unlikely to be dyed on a cloth) may occur, the difference in color development property between the front and the rear surfaces of the printed matter may be generated since the penetrant is dried before the permeation thereof, or the difference in color development property between the front and the rear surfaces of the printed matter may be generated since the penetrant is not likely to be dried.

On the other hand, according to this embodiment, since the penetrant having a predetermined composition is used, the dyeing inhibition is not likely to occur, and hence, a printed matter in which the difference in color development property between the front and the rear surfaces is reduced can be obtained. Hereinafter, the details of the recording method will be described.

### 2.1. Ink Adhesion Step

The ink adhesion step is a step of adhering an aqueous dye ink containing a reactive dye, an acidic dye, or a disperse dye to a cloth by an ink jet method.

The ink jet method is not particularly limited, and for example, a charge deflection method, a continuous method, or an on-demand method (piezoelectric type, or bubble jet (registered trademark) type) may be mentioned.

In the ink jet recording method of this embodiment, the ink adhesion step may include a reactive/acidic ink adhesion step of adhering a first aqueous dye ink containing a reactive dye or an acidic dye to a cloth by an ink jet method and a disperse ink adhesion step of adhering a second aqueous dye ink containing a disperse dye to the cloth by an ink jet method.

As described above, the ink jet printing penetrant of this embodiment can be applied not only to printing using an acidic dye or a reactive dye but also to printing using a disperse dye. Hence, a penetrant for an acidic dye or a reactive dye is not required to be prepared separately from a penetrant for a disperse dye.

In addition, in the ink jet recording method of this embodiment, the ink adhesion step is not limited to the method including a reactive/acidic ink adhesion step of adhering a first aqueous dye ink to a cloth by an ink jet method and a disperse ink adhesion step of adhering a second aqueous dye ink to the cloth by an ink jet method and may be a method including only one of the reactive/acidic ink adhesion step and the disperse ink adhesion step.

### 2.1.1. Ink Composition

The ink composition may contain a dye, a solvent, a surfactant, an urea, a saccharide, a pH adjuster, a chelating agent, a fungicide, an antirust agent, and/or other components.

The dye is not particularly limited, and for example, there may be mentioned an acidic dye, such as C.I. Acid Yellow, C.I. Acid Red, C.I. Acid Blue, C.I. Acid Orange, C.I. Acid Violet, or C.I. Acid Black; a basic dye, such as C.I. Basic Yellow, C.I. Basic Red, C.I. Basic Blue, C.I. Basic Orange, C.I. Basic Violet, or C.I. Basic Black; a direct dye, such as C.I. Direct Yellow, C.I. Direct Red, C.I. Direct Blue, C.I. Direct Orange, C.I. Direct Violet, or C.I. Direct Black; a reactive dye, such as C.I. Reactive Yellow, C.I. Reactive Red, C.I. Reactive Blue, C.I. Reactive Orange, C.I. Reactive Violet, or C.I. Reactive Black; or a disperse dye, such as C.I. Disperse Yellow, C.I. Disperse Red, C.I. Disperse Blue, C.I. Disperse Orange, C.I. Disperse Violet, or C.I. Disperse Black. Those dyes may be used alone, or at least two types thereof may be used in combination.

As the dye, a commercial product may also be used. For example, Genesta (registered trademark) RE-N Black (reactive dye) or Genesta DS Black (disperse dye) may be mentioned.

### 2.1.2. Cloth

Fibers forming a cloth is not particularly limited, and for example, there may be mentioned natural fibers, such as silk, cotton, hemp, or wool fibers; synthetic fibers, such as polyester fibers, nylon fibers, triacetate fibers, diacetate fibers, or polyamide fibers; or regenerated fibers, such as rayon fibers. As the cloth, a cloth formed from one type of fibers or a cloth formed by blending at least two types of fibers may be used. Among those mentioned above, as the cloth, in particular, a blended cloth formed by blending at least two types of fibers having different permeabilities is preferably used.

In the past, for example, in many cases, a disperse dye was used for polyester fibers, and a reactive dye was used for fibers (such as cotton fibers) containing cellulose as a primary component. In addition, a penetrant for an acidic dye or a reactive dye is required to be used separately from a penetrant for a disperse dye.

On the other hand, the ink jet printing penetrant of this embodiment may be used not only for printing using an acidic dye or a reactive dye but also for printing using a disperse dye.

Hence, the ink jet printing penetrant of this embodiment may also be preferably used for a blended cloth formed by blending different types of fibers.

As the cloth, the fibers described above may be used in the form of a woven, a knitted, or a nonwoven cloth.

The combination between the cloth and the dye is not particularly limited, and for example, there may be mentioned a combination between a reactive dye and fibers (such as cotton, hemp, or rayon fibers) containing cellulose as a primary component; a combination between an acidic dye and silk, wool, or nylon fibers; a combination between a basic dye and acrylic fibers; a combination between a direct dye and cotton, hemp, or rayon fibers; or a combination between a disperse dye and polyester fibers. Among those combinations described above, the combination between a reactive dye and fibers containing cellulose as a primary component or the combination between an acidic dye and silk, wool, or nylon fibers is preferable. By the combination as described above, the difference in color development property between the front and the rear surfaces of a printed matter tends to be further reduced. However, the combination between the cloth and the dye is not limited to those described above.

### 2.2. Penetrant Adhesion Step

The penetrant adhesion step is a step of adhering the ink jet printing penetrant of this embodiment to the cloth by an ink jet method. A method to adhere the penetrant is not particularly limited, and for example, a roller method, a spray method, or an ink jet method may be mentioned. Among those mentioned above, since the penetrant can be selectively adhered, an ink jet method is preferable.

The penetrant adhesion step may be performed before, after, or simultaneously with the ink adhesion step.

When the penetrant adhesion step is performed before the ink adhesion step, before the penetrant adhered to the cloth is dried, the ink adhesion step is preferably performed. In addition, when the penetrant adhesion step is performed after the ink adhesion step, before or after the ink composition adhered to the cloth is dried, the penetrant adhesion step can be performed and is preferably performed before the ink composition adhered to the cloth is dried. In addition, the penetrant may be adhered to the front surface, the rear surface, or both the front and the rear surfaces of the cloth.

### 2.3. Heating Step

The ink jet recording method of this embodiment may further include, after the ink adhesion step and the penetrant adhesion step, a heating step of heating the cloth. Since the heating step is included, the dye can be more preferably dyed on fibers forming the cloth. A heating method is not particularly limited, and for example, there may be mentioned a HT method (high-temperature steaming method), an HP method (high-pressure steaming method), or a thermosol method.

In addition, in the heating step, a pressure treatment may be or may not be performed on the surface of the cloth to which the ink composition is adhered. As a heating method not to perform a pressure treatment on the surface of the cloth to which the ink composition is adhered, an oven drying method (method using a conveyor oven, a batch oven, or the like not to perform a press treatment) may be mentioned. Since the heating step as described above is included, a recorded matter productivity can be further improved. In addition, a heating method which also performs a pressure treatment on the surface of the cloth to which the ink composition is adhered is not particularly limited, and for example, a heat press method or a wet-on-dry method may be mentioned. In addition, the “pressure treatment” indicates a treatment in which a pressure is applied to a recording medium by bringing an object into contact therewith.

A temperature in the heating step is preferably 50° C. to 150° C. and more preferably 60° C. to 110° C. Since the temperature in the heating step is in the range described above, the dye tends to be more preferably dyed on fibers forming the cloth.

### 2.4. Washing Step

The ink jet recording method of this embodiment may further include, after the heating step, a washing step of washing the cloth. By the washing step, a dye not to be dyed on the fibers can be effectively removed. The washing step can be performed using water or the like, and if needed, a soaping treatment may also be performed. The soaping treatment is not particularly limited, and for example, a method in which an unfixed pigment is washed out with a hot soap liquid or the like may be mentioned.

### EXAMPLES

Hereinafter, the present disclosure will be described in more detail with reference to Examples and Comparative Examples. The present disclosure is not limited at all to the following Examples.

### Ink

Inks used in the following Examples and Comparative Examples are as described below.
Genesta RE-N Black (reactive dye ink)
Genesta DS Black (disperse dye ink)

### Materials of Ink Jet Printing Penetrant

Main materials of the ink jet printing penetrants used in the following Examples and Comparative Examples are as shown below.

### Lactam Compound

1-(2-hydroxyethyl)-2-pyrrolidone
1-(2-hydroxyethyl)-3-methyl-2-pyrrolidone
4-hydroxy-2-pyrrolidone
6-hydroxymethyl-2-piperidone
2-pyrrolidone

### Glycol

Propylene glycol (vp: 10.6 Pa)
Ethylene glycol (vp: 7 Pa)
1,3-butanediol (vp: 8 Pa)
2,3-butanediol (vp: 12 Pa)
Diethylene glycol (vp: <0.8 Pa)
2-methyl-2,4-pentanediol (vp: 6.7 Pa)
methanediol (vp: 16.1 Pa)

### Alcohol Other Than Glycols

2-ethyl-1-hexanol (vp: 48 Pa)

### pH Adjuster

triisopropanolamine
triethanolamine

### Surfactant

Olfine PD002W (acetylene glycol-based surfactant, manufactured by Nissin Chemical Industry Co., Ltd.)

### Fungicide

Proxel XL-2 (manufactured by arxada JAPAN)

### Preparation of Ink Jet Printing Penetrant

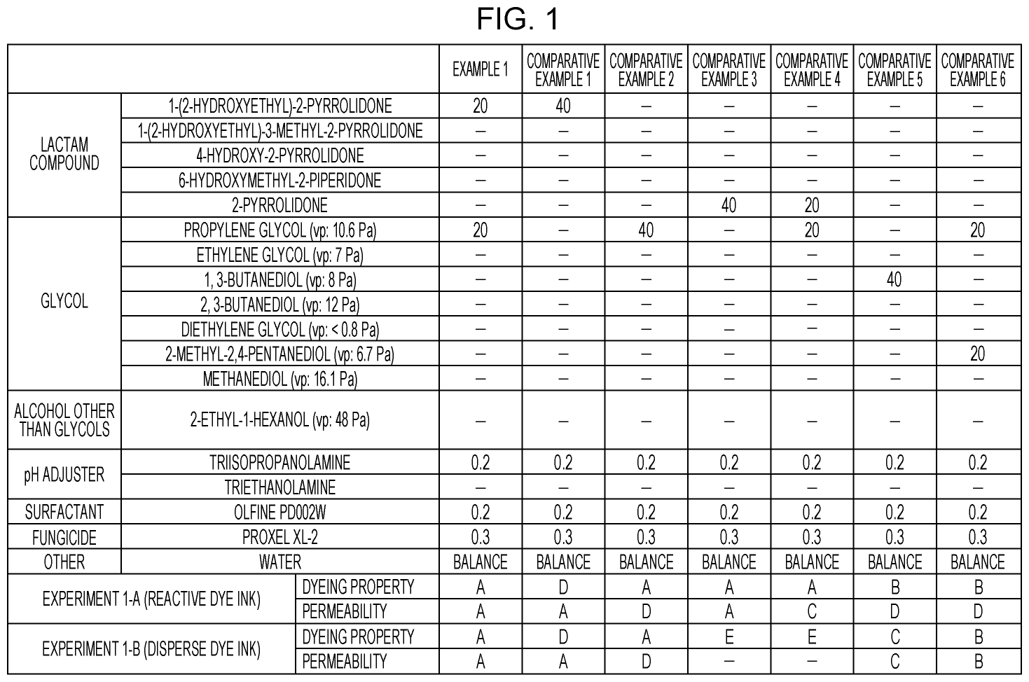

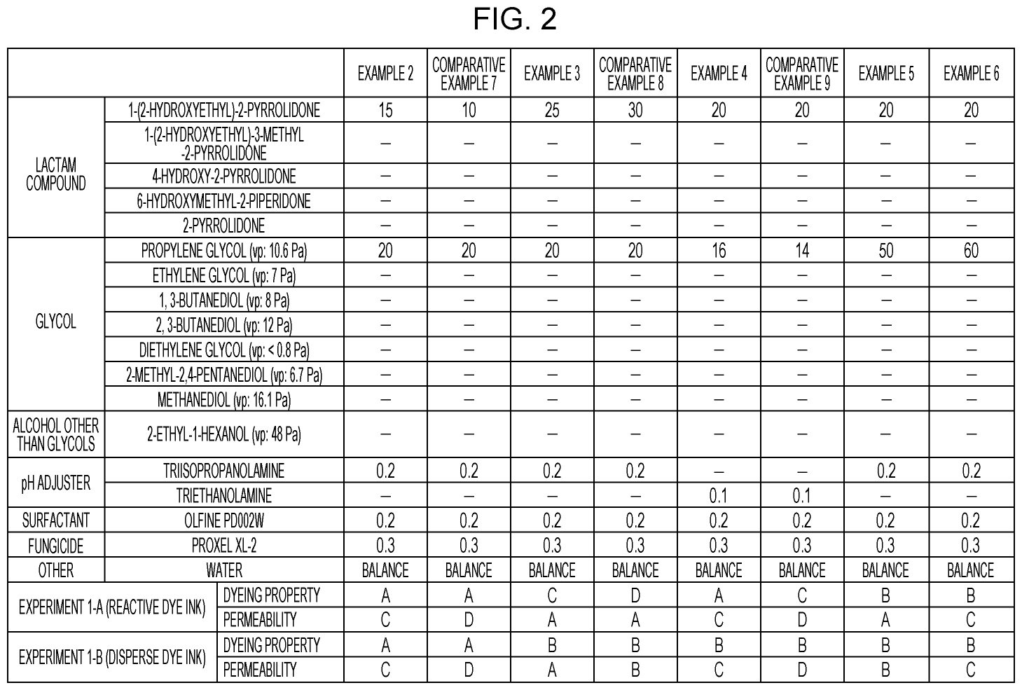

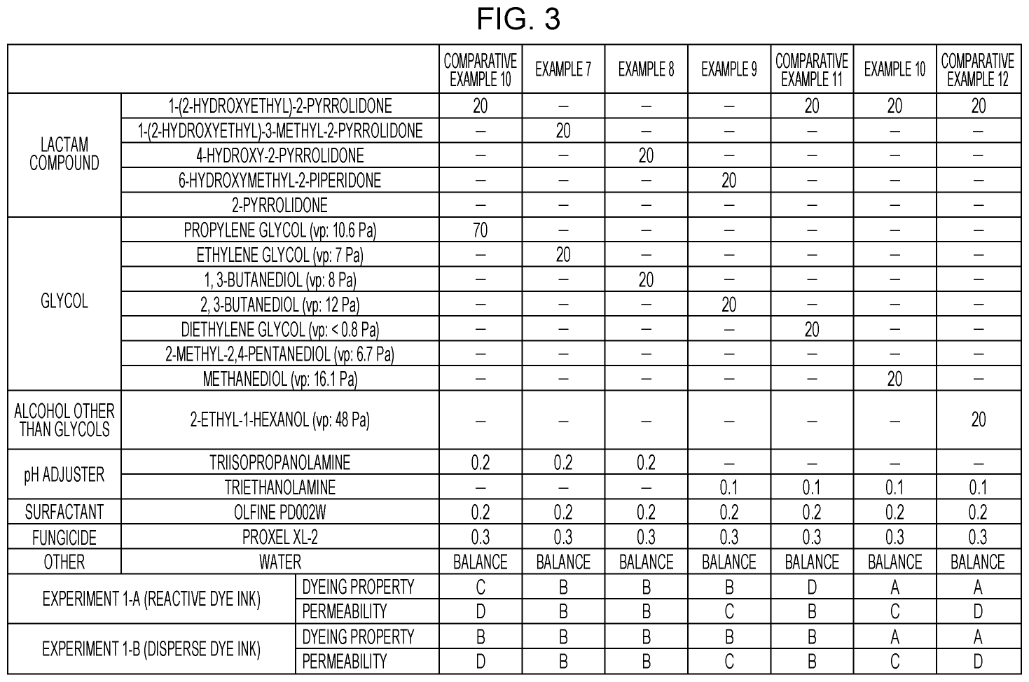

Materials were mixed together to obtain one of the compositions shown in FIGS. 1 to 4 and then sufficiently stirred, so that each ink jet printing penetrant was obtained. In addition, in the following FIGS. 1 to 4, the numerical values are each on a percent by mass basis, and the total is set to 100.0 percent by mass.

### Experiment 1-A

### Sample 1

1) The above Genesta RE-N Black (reactive dye ink) and penetrant were filled in a cartridge of an ink jet printer SurePress FP-30160 (manufactured by Seiko Epson Corporation). After a cloth 1 (cotton, COT-PTR (manufactured by Epson Como Printing Technologies Srl)) was set in the printer, solid printing was performed with a mode of 900×600 dpi, so that the ink and the penetrant were adhered to the front surface of the cloth 1 so as to have a mass per unit area of 2.3 to 2.5 mg/cm².
2) After the printing was performed, the cloth 1 thus treated was pre-dried at 60° C. by a hot-wind heater and was then left for one day, and the following steam and washing treatment was performed.

### Steam and Washing Treatment

After streaming was performed at 102° C. for 12 minutes, washing was performed with cold water for 10 minutes. Subsequently, hot water washing was performed for 6 minutes with hot water at 90° C. in which, as a detergent, Laccol A (manufactured by Meisei Chemical Works, Ltd.) was added at 2 g/L with respect to washing water, and water washing was then performed for 10 minutes.
3) The cloth was dried using a hot-wind dryer, so that a printed cloth of Sample 1 was obtained.

### Dyeing Property and Permeability

The OD values (optical density) of the front and the rear surfaces of the printed cloth thus obtained were measured using a fluorescent spectroscopic densitometer FD-7 (viewing angle: 10°, light source: D65, with UV cut filter) manufactured by Konica Minolta, Inc., so that the OD value (front surface) and ΔEcmc (2:1) in OD value between the front and the rear surfaces were obtained.

For the evaluation of dyeing property, the OD value (front surface) was evaluated in accordance with the following evaluation criteria.

For the evaluation of permeability, the ΔEcmc (2:1) value between the front and the rear surfaces was evaluated in accordance with the following evaluation criteria.

### Evaluation Criteria

A: OD value (front surface) is 1.6 or more.
B: OD value (front surface) is 1.5 to less than 1.6.
C: OD value (front surface) is 1.4 to less than 1.5.
D: OD value (front surface) is less than 1.4.

### Evaluation Criteria

A: ΔEcmc (2:1) is 1.0 or less.
B: ΔEcmc (2:1) is more than 1.0 to 1.5.
C: ΔEcmc (2:1) is more than 1.5 to 2.0.
D: ΔEcmc (2:1) is more than 2.0.

### Experiment 1-B

### Sample 2

Except for that Genesta RE-N Black (reactive dye ink) was changed to Genesta DS Black (disperse dye ink), the cloth 1 (cotton, COT-PTR) was changed to a cloth 2 (polyester, PES-PT (manufactured by Epson Como Printing Technologies Srl), and the steam and washing treatment was changed to the following steam and washing treatment, a printed cloth of Sample 2 of Experiment 1-B was obtained in a manner similar to that of the method described in Sample 1 of Experiment 1-A.

### Steam and Washing Treatment

After streaming was performed at 170° C. for 8 minutes, washing was performed with cold water for 10 minutes. Subsequently, hot water washing was performed for 6 minutes with hot water at 85° C. in which with respect to washing water, Laccol A (manufactured by Meisei Chemical Works, Ltd.) was added as a detergent at 2 g/L, and hydrosulfite and sodium hydroxide were also simultaneously added each at 2 g/L, and water washing was then performed for 10 minutes.

### Dyeing Property and Permeability

The OD value (front surface) and the ΔEcmc (2:1) between the front and the rear surfaces of Sample 2 were obtained by a method similar to that described in “DYEING PROPERTY AND PERMEABILITY” of “EXPERIMENT 1-A”.

As the dyeing property evaluation, the OD value (front surface) was evaluated in accordance with the following evaluation criteria.

As the permeability evaluation, the ΔEcmc (2:1) value between the front and the rear surfaces was evaluated in accordance with evaluation criteria similar to those described in “DYEING PROPERTY AND PERMEABILITY” of “EXPERIMENT 1-A”.

### Evaluation Criteria

A: OD value (front surface) is 1.5 or more.
B: OD value (front surface) is 1.4 to less than 1.5.
C: OD value (front surface) is 1.3 to less than 1.4.
D: OD value (front surface) is less than 1.3.
E: No dyeing occurs.

As shown in FIGS. 1 to 3, among Examples in each of which an ink jet printing penetrant containing a lactam compound having a hydroxy group and a glycol having a vapor pressure of 1.0 to 20.0 Pa at 20° C. is used, the content of the lactam compound with respect to the total mass of the ink jet printing penetrant is 15 to 25 percent by mass, and the content of the glycol with respect to the total mass of the lactam compound is 0.8 to 3.0 on a mass ratio basis, in Experiment 1-A and Experiment 1-B, the dyeing property and the permeability are evaluated excellent. Hence, in Examples, the ink is able to permeate through to the rear surface of the cloth, and hence an image having a preferable color development property not only on the front surface but also on the rear surface can be obtained.

On the other hand, Comparative Example 1 which contains no glycol having a vapor pressure of 1.0 to 20.0 Pa at 20° C. is inferior in dyeing property. When Comparative Example 3 or 4 which contains no lactam compound having a hydroxy group is used with a disperse dye ink, the dyeing property is inferior. When Comparative Example 8 in which the content of the glycol with respect to the total mass of the lactam compound is less than 0.8 on a mass ratio basis is used with a reactive dye ink, the dyeing property is inferior. Comparative Example 10 in which the mass ratio described above is more than 3.0 has an inferior permeability.

### Experiment 2

### Sample 3

1) The following reactive ink pre-treatment liquid was applied to a cloth 3 (T40, blended broadcloth of 65% of polyester and 35% of cotton, manufactured by Nisshinbo Holdings Inc.) at a pickup rate of 30% using a mangle and was then dried, so that a printing cloth was formed.

### Composition of Reactive Ink Pre-Treatment Liquid

Sodium alginate 1 percent by mass
Guar gum 1 percent by mass
Ammonium sulfate 4 percent by mass
Urea 10 percent by mass
Water 84 percent by mass
2) The above Genesta RE-N Black (reactive dye ink), Genesta DS Black (disperse dye ink), and penetrant were filled in a cartridge of an ink jet printer SurePress FP-30160 (manufactured by Seiko Epson Corporation).

In the case described above, Genesta RE-N Black (reactive dye ink) and Genesta DS Black (disperse dye ink) were filled in a Black row and an Orange row, respectively, of the ink jet printer SurePress FP-30160 (manufactured by Seiko Epson Corporation).
3) After an application rate between a disperse dye ink and a reactive dye ink was adjusted at approximately 65 to 35, solid printing was performed with a mode of 900×600 dpi, so that the ink and the penetrant were adhered to the front surface of the printing cloth so as to have a mass per unit area of 2.3 to 2.5 mg/cm².
2) After the printing was performed, the cloth thus treated was pre-dried at 60° C. by a hot-wind heater and was then left for one day, and the following steam and washing treatment was then performed.

### Steam and Washing Treatment

After streaming was performed at 170° C. for 8 minutes, washing was performed with cold water for 10 minutes. Subsequently, hot water washing was performed for 6 minutes with hot water at 85° C. in which with respect to washing water, as a detergent, Laccol A (manufactured by Meisei Chemical Works, Ltd.) was added at 2 g/L, and hydrosulfite and sodium hydroxide were also simultaneously added each at 1 g/L, and water washing was then performed for 10 minutes.
3) The cloth thus treated was dried by a hot-wind dryer, so that a printed cloth of Sample 3 was obtained.

### Dyeing Property and Permeability

The OD value (front surface) and the ΔEcmc (2:1) between the front and the rear surfaces of Sample 3 were obtained by a method similar to that described in “DYEING PROPERTY AND PERMEABILITY” of “EXPERIMENT 1-A”.

As the dyeing property evaluation, the OD value (front surface) was evaluated in accordance with evaluation criteria similar to those described in “DYEING PROPERTY AND PERMEABILITY” of “EXPERIMENT 1-B”.

As the permeability evaluation, the ΔEcmc (2:1) value between the front and the rear surfaces was evaluated in accordance with evaluation criteria similar to those described in “DYEING PROPERTY AND PERMEABILITY” of “EXPERIMENT 1-A”.

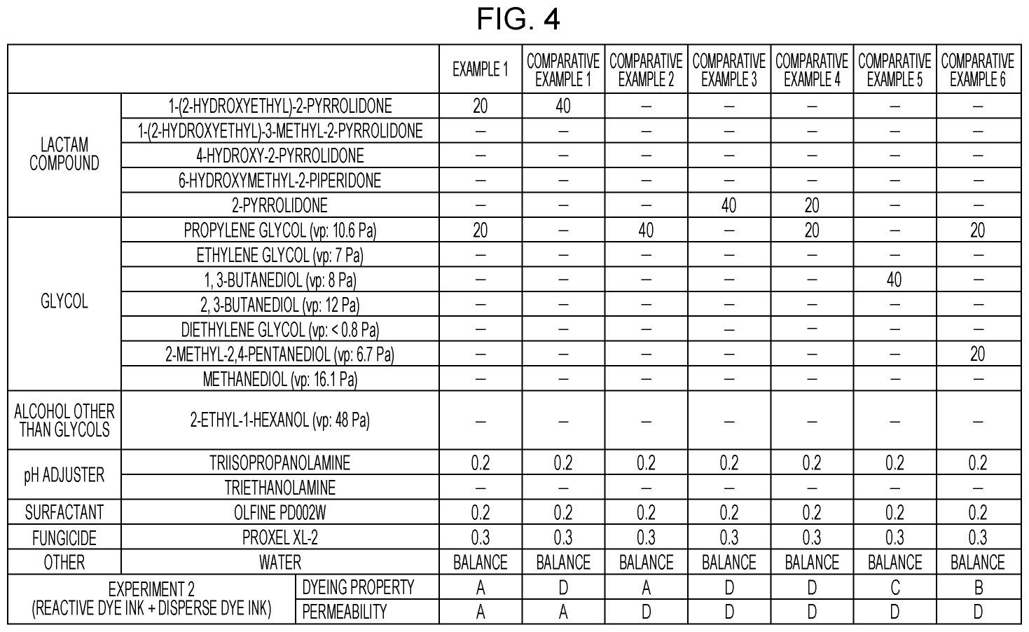

As shown in FIG. 4, among Examples in each of which the ink jet printing penetrant of this embodiment is used, in Example 2, the dyeing property and the permeability are evaluated excellent. Hence, in Examples, even when a blended cloth between a polyester and cotton is used, the ink is able to permeate through to the rear surface of the cloth, and as a result, an image having a preferable color development property not only on the front surface but also on the rear surface can be obtained.

On the other hand, according to Comparative Example 1 in which no glycol having a vapor pressure of 1.0 to 20.0 Pa at 20° C. is contained, the dyeing property is inferior. According to Comparative Examples 3 and 4 in each which no lactam compound having a hydroxy group is contained, the dyeing property and the permeability are inferior.

What is claimed is:

1. An ink jet printing penetrant comprising:
a lactam compound having a hydroxy group; and
a glycol having a vapor pressure of 1.0 to 20.0 Pa at 20° C.,
wherein a content of the lactam compound with respect to a total mass of the ink jet printing penetrant is 15 to 25 percent by mass, and
a content of the glycol with respect to a total mass of the lactam compound is 0.8 to 3.0 on a mass ratio basis.

2. The ink jet printing penetrant according to claim 1, wherein a content of the glycol with respect to the total mass of the ink jet printing penetrant is 20 to 50 percent by mass.

3. The ink jet printing penetrant according to claim 1, wherein the lactam compound includes at least one selected from the group consisting of 1-(2-hydroxyethyl)-2-pyrrolidone, 1-(2-hydroxyethyl)-3-methyl-2-pyrrolidone, 4-hydroxy-2-pyrrolidone, and 6-hydroxymethyl-2-piperidone.

4. The ink jet printing penetrant according to claim 1, wherein the glycol includes propylene glycol.

5. The ink jet printing penetrant according to claim 1, further comprising a colorant,
wherein a content of the colorant is 0.1 percent by mass or less.

6. The ink jet printing penetrant according to claim 1, further comprising a solid component,
wherein a content of the solid component is 1.0 percent by mass or less.

7. An ink jet recording method comprising:
an ink adhesion step of adhering an aqueous dye ink containing a reactive dye, an acidic dye, or a disperse dye to a cloth by an ink jet method; and
a penetrant adhesion step of adhering the ink jet printing penetrant according to claim 1 to the cloth by an ink jet method.

8. The ink jet recording method according to claim 7,
wherein the ink adhesion step comprises:
a reactive/acidic ink adhesion step of adhering a first aqueous dye ink containing a reactive dye or an acidic dye to the cloth by an ink jet method; and
a disperse ink adhesion step of adhering a second aqueous dye ink containing a disperse dye to the cloth by an ink jet method.

9. The ink jet recording method according to claim 7,
wherein the cloth includes a blended cloth.
